(19) United States
(12) Patent Application Publication
(10) Pub. No.: US 2015/0231016 A1
(43) Pub. Date: Aug. 20, 2015

(54) Therapeutic Compression Apparatus

(71) Applicants: Dana Stearns, Walpole, MA (US); Lisa Stearns, Walpole, MA (US)

(72) Inventors: Dana Stearns, Walpole, MA (US); Lisa Stearns, Walpole, MA (US)

(21) Appl. No.: 14/627,617

(22) Filed: Feb. 20, 2015

Related U.S. Application Data
(60) Provisional application No. 61/942,296, filed on Feb. 20, 2014.

(51) Int. Cl. A61H 1/00

(52) U.S. Cl. CPC A61H 1/008

(57) ABSTRACT

A massage and rehabilitation system utilizing therapeutic compression apparatuses and methods. Vertical and horizontal adjustments are incorporated, as well differing size, number and flexure massage heads. The massage and rehabilitation system affords the professional or user numerous degrees of adjustment.

### CROSS REFERENCE TO RELATED APPLICATION

This application takes priority from and claims the benefit of U.S. Provisional Patent Application Ser. No. 61/942,296 filed on Feb. 20, 2014, the contents of which are herein incorporated by reference.

### FIELD OF THE INVENTION

The present invention relates to a therapeutic compression apparatus, and more particularly to self-directed, vertically mounted massage systems to provide therapeutic compression from unlimited angles to a body.

### BACKGROUND OF THE INVENTION

The human musculoskeletal system is an organ system that gives humans the ability to move using both their muscular and skeletal systems. It is made up of the bones of the skeleton, muscles, cartilage, tendons, ligaments, joints, and other connective tissue that supports and binds tissues and organs together. The musculoskeletal system's primary functions include support, form, stability, protection, and movement to the body. Some of the musculoskeletal system is like plastic: ligaments, muscles, tendons and tissues will adapt to their surrounding and they will conform to certain positions and lengthen, stiffen, or soften depending upon the situation.

Different changes to the musculoskeletal system can cause damage to the system with much needed adaptation to repair and recover from the damage. Scar tissue is a byproduct of the process between damage to repair and recovery. While some scar tissue is good, while other scar tissue can be restrictive and bad, all scar tissues is quite inflexible. Scar tissue may tether and hurt adjacent tissues, making the tissue less mobile and therefore cause pain.

Massage involves the manipulation of muscle and connective tissue to enhance the function of those tissues, replenish stressed and overworked muscles, and promote relaxation and well-being. Therapeutic massage can ease tension and reduce pain, and can also be highly effective for reducing the symptoms of arthritis, back pain, and other disorders of the muscles. There are established techniques designed to release scar tissues tethering muscles tendons and ligaments and to stimulate tissue circulation in an effort to improve overall mobility, fluidity, and range of motion. Plenty of research has supported the use of massage techniques employed by both professionals such as physical therapists and masseuses, and employed by individuals themselves in an overall wellness program to improve overall fitness and reduce injury.

One specific type of tissue that may require therapeutic massaging is fascia after it scars. Fascia forms a barrier between cell types while simultaneously connecting the cell types together and allowed communications (via nerves and blood vessels) between them. Fascia covers all organs, including muscles, bones, and vital organs of the body.

Deep fascia is a dense, inelastic, parallel fibrous membrane that forms sheaths that surround individual muscles and entire muscle groups. Deep fascia also separates muscle groups from bones as well as surrounds and separates internal organs from one another in the body.

Superficial fascia connects the skin with the deep fascia over almost the entire surface of the body. It contains loosely formed strands of fiber mixed with fat to form a soft compressible tissue layer.

Scarring of the fascia may occur as a result of healing after local trauma such as an injury or surgery. Scarring may also occur during repair or adaptation of the system to acute or repetitive physical stressors such as training. When excessive tension or pressure on muscles organs, nerves and vessels occurs, restricted fascia, also known as adhesions may form. These adhesions may result from local trauma or even repetitive motion or overuse of a muscle.

Adhesions and stress in fascia are not always obvious on X-rays, CAT scans, MRI's or electromyography (EMG) causing fascia restrictions to be difficult to identify within a patient. Massage therapy is a known solution to relieve fascia restrictions.

Current massage devices that exist to help relieve stress in the fascia have varying limitations. For one, most products require the user to be in the “supine” or “prone” position. For some users this position may be difficult or near impossible to achieve due to certain back injuries. Other products are designed to be placed on the floor in order to provide a firm platform/table for individual. Although the floor is a sufficient support device, some users are unable to use the floor either because they may have trouble getting down to the floor or getting up after performing the therapy.

Further, self-massage products require self-manipulation by the user. These products usually are designed for back-use only. Many users are not able to access posterior corpus areas well enough—“hard to reach areas.” Even if a user may reach a hard to reach target area, they are unable to provide enough force or pressure to the area for sufficient relief.

### SUMMARY OF INVENTION

In one aspect, the present invention provides a new therapeutic compression apparatus for pain management within the human body, which includes an adjustable mechanism to reach all pained areas in the body. In another aspect, the present invention provides a new therapeutic compression apparatus, which includes a massage probe that may be manually adjusted and changed by a user to reach all potential pained areas easily, frequently, and repetitively.

In another aspect, the invention provides a new therapeutic compression apparatus that is lighter and compact and size and may be travel with the user conveniently. Further, an even other aspect, the invention provides a new therapeutic compression mechanism that is less expensive to make and purchase. Another aspect of the invention is to provide a new therapeutic compression mechanism that is user friendly, easy to set up and use.

Realizing one aspect of the invention is a therapeutic compression apparatus that may be used for pain management within the human body, includes an adjustable mechanism to reach all pained areas in the body, an adjustable and changeable massage probe. The therapeutic compression apparatus is lighter, more compact, less expensive, easy to use, and safer.

In the several embodiments, there exists a system that may be permanently mounted or portably disposed and may also comprise a base-and-post configuration. The system may also comprise an industrial version and a home borne version. The contact devices would be the same and interchangeable with those used with the industrial/home version.

The subject invention features a therapeutic compression apparatus that may have a pair of elongated, substantially parallel structural base members. The base members may run vertically along a support structure like a wall or a door frame. The base members are attached to a wall by a plurality of substantially parallel attachment struts that run parallel and are in between the elongated base members. The elongated substantially parallel structural base members further include an elongated track that also may run vertically. Attached to the elongated track is at least one adjustable post member.

The post member is slideably attached to the track and can be adjusted by a user to an appropriate height specific to the body area needing massage therapy. Attached to the post member through at least one receptor hole is a detachable massage device post. The post is manually moved upwardly and downwardly to make contact with any potential pained areas in the body.

The massage device post is also changeable by the user and different massage device posts may be chosen depending on the type of pain and type of massage the user wishes to use. Some massage post examples include spheres, pegs, dual spheres, and cylinder massage heads. These massage heads may also be made of different compressible material to provide user with more or less desired pressure. The detachable massage post has a distance long enough to reach the user's desired contact point, rotates 270 degrees around an axis and has a vertical orientation of 360 degrees.

In one embodiment, a method of utilizing a therapeutic compression apparatus is illustrated. The method comprises the steps of attaching the base member to a stable surface, attaching a vertically disposed elongated track system to the base system, attaching one or more, but at least one adjustable post retaining member, attaching one or more, but at least one post member to the adjustable post retaining member, attaching one or more, but at least treatment member comprising a point of contact to the corresponding post member(s), and adjusting the at adjustable post retaining member(s), the post member(s) and the treatment mechanism(s) to the areas of the boy wherein treatment is desired.

The post members are thus designed to extend the shaped treatment member, and the point of contact away from the wall. Thus, this distance allows the user to rotate the contact point up to 270 degrees (as alluded to above) around the axis of the contact point—this is impossible to accomplish with current devices on the floor, or a ball against the wall. The increased rotation allows the user to adjust the therapy far more accurately and effectively.

This portion of the device can be vertically adjusted on the base to the desired height by the user. This allows the user to treat the same muscles along their entire length, multiple muscle groups, tendons and ligaments in difficult to reach areas along the spine, thoraco-abdominal back musculature, shoulders and hips far more effectively.

The contact point can be easily secured at a particular height—this allows the user to treat the contact point in a 360 degree vertical orientation.

In another embodiment, the therapeutic compression apparatus may include a vibration device, which may be attached to the substantially parallel attachment struts along the elongated base members.

It is therefore an object of the invention to provide an apparatus for user pain management through massage therapy.

It is another object of the invention to provide an apparatus that may be used for myofascial release.

It is another object of this invention to open fascial restrictions that tether tissues.

It is another object of this invention to improve muscular stretch and contraction and flexibility by allowing the layers of tissue to move more freely.

It is another object of this invention to increase joint range of motion. It is another object of this invention to release normal scar tissues surrounding nerve and blood vessels traveling between muscle bone and skin.

It is another object of this invention to reduce pain caused by nerve entrapment and improve circulation.

It is another object of this invention to provide a self-treatment massage device for reducing the need for a user to seek out repetitive massage therapy sessions.

It is yet another object of this invention to provide a light, more compact, user friendly massage therapy device that is also safe and affordable.

There has thus been outlined, rather broadly, the more important features of the versatile integrated foldable container system and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

Other objects, features and advantages will occur to those skilled in the art from the following description of a preferred embodiment and the accompanying drawings, in which:

FIG. 1 is a front perspective view of a user applying pressure to a pained area through the use of an embodiment of the present invention;

FIG. 2 is a front view of a detachable massage device post;

FIG. 3 is a cross-section view of a detachable massage head device attached to an adjustable post member through a receptor hold in the post member;

FIG. 4 is a front view of another embodiment of the current invention;

FIG. 5 is a front perspective view of an embodiment of the current invention;

FIG. 6 is a side view of yet another embodiment of the current invention;

FIG. 7 is a front perspective of a parallel attachment strut, used to position the therapeutic compression apparatus to a support structure like a wall;

FIG. 8 is an example of a detachable massage post head;

FIG. 9 is an example of a detachable massage post head illustrated a pliable massage head;

FIG. 10 illustrates an embodiment of a singular detachable massage post head being utilized on an individual;

FIG. 11 illustrates a dual spherical detachable massage post head; and,

FIG. 12 illustrates the dual spherical detachable massage post head being utilized on an individual.

### DETAILED DESCRIPTION OF THE SEVERAL EMBODIMENTS

The detailed description set forth below is intended as a description of presently preferred embodiments of the invention and does not represent the only forms in which the present invention may be construed and/or utilized. The description sets forth the functions and the sequence of the steps for producing the system and accompanying apparatus. However, it is to be understood that the same or equivalent functions and sequences may be accomplished by different embodiments also intended to be encompassed within the scope of the invention.

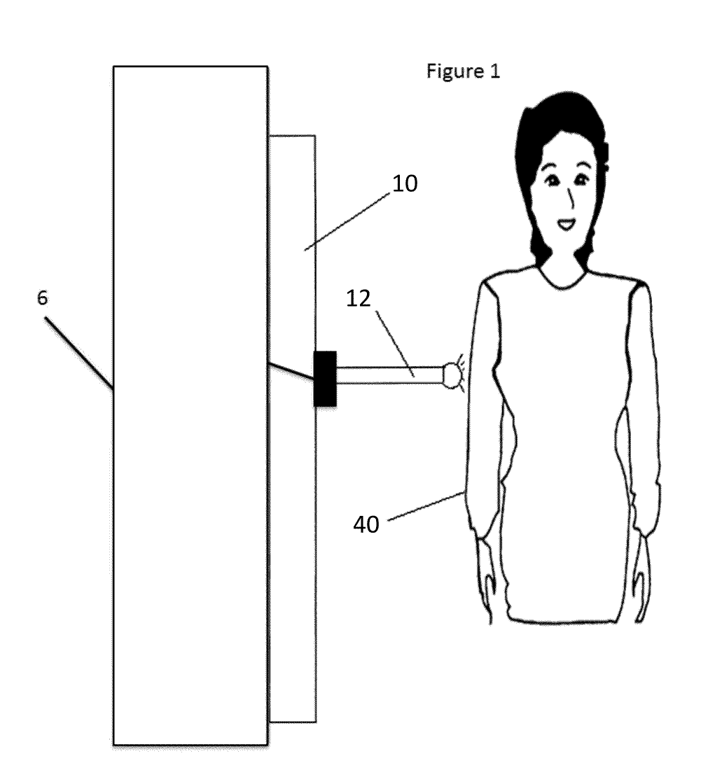

Referring now to FIG. 1 is a perspective view of a user utilizing the therapeutic compression apparatus. The user equips the apparatus 2 with the two elongated substantially parallel base members 10 vertically along a support structure 6 like a wall or doorframe. The user may adjust the adjustable post retaining member 8 to a desired height. The user 40 then stands in front of the apparatus 10 and positions the detachable massage device post 12 at the approximate height of the affected body area. At this point the user 40 leans into the post 12 and uses the movement of the body to firmly massage the affected area with the massage head of the detachable massage device post 12.

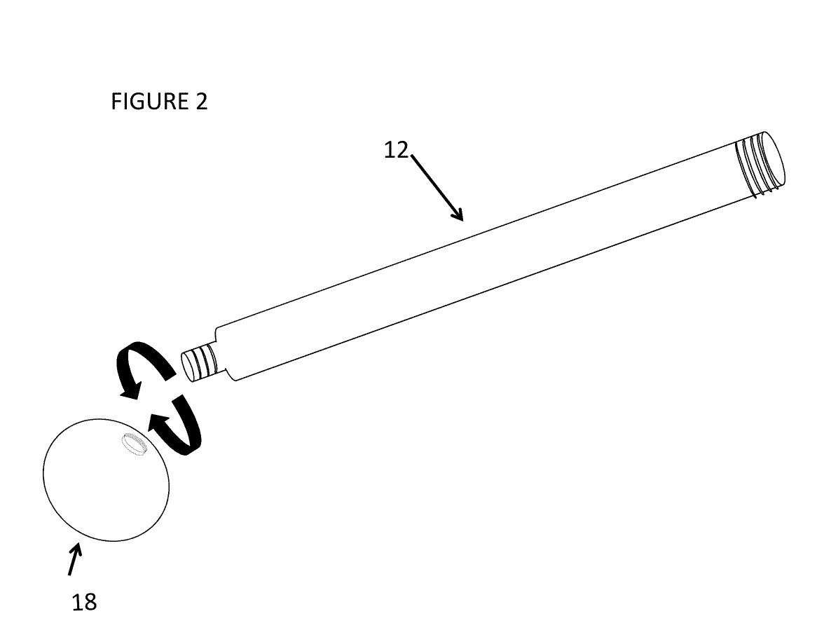

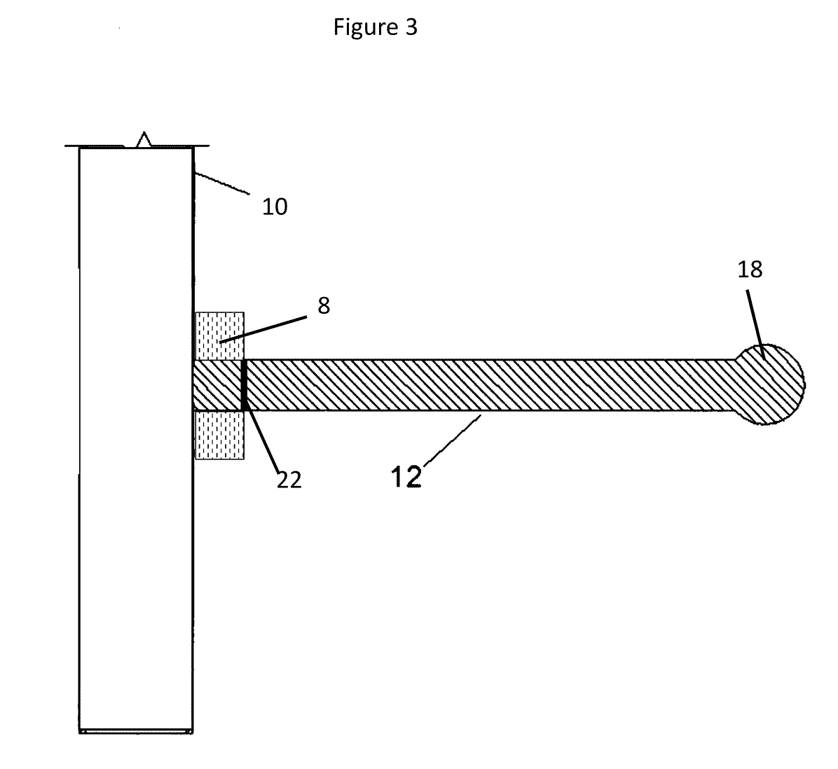

FIG. 2 shows a more detailed version of a detachable massage device post 12. Here, a rounded probe is shown as a massage head 18. The length of the post is approximately can be differing sizes and comprises a washer 20. The leading and terminating edge of the small diameter of the massage device post 12 incorporates a fillet radius 44 for ease of inserting the post 12 into a receptor hole 22 (as seen in FIG. 3). The massage head 18 may have many shapes i.e. cylindrical, forked, etc. The massage head 18 may be fabricated from a variety of materials i.e. stainless steel, rubber, plastic, composite material, etc.

FIG. 3 illustrates a cross-section view of the detachable massage device post 12 attached to the adjustable post member 8 through a receptor hole 22.

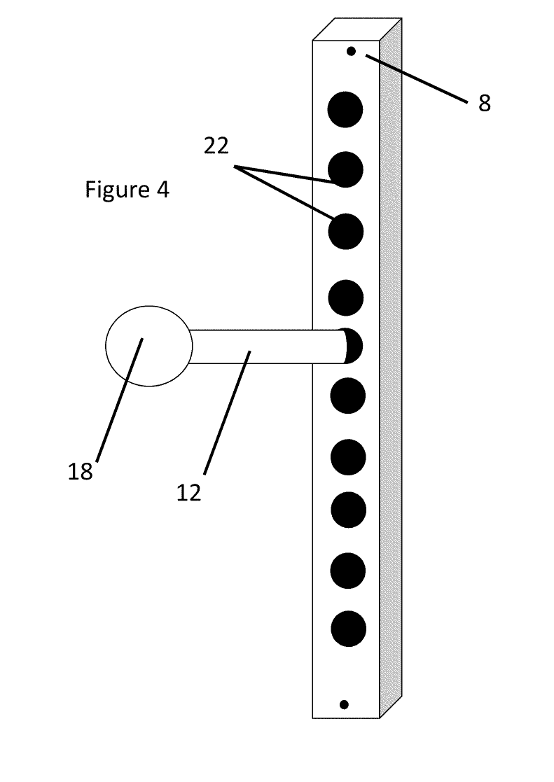

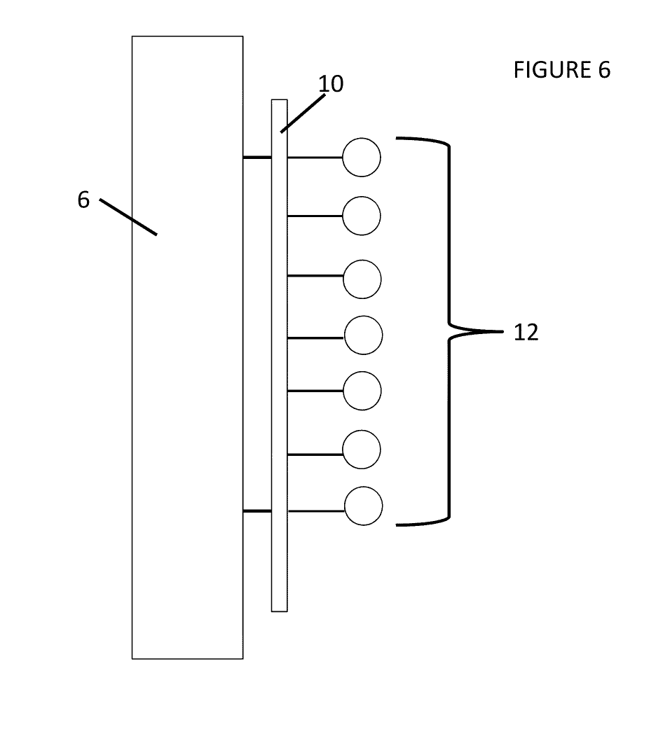

FIG. 4 illustrates one embodiment of the current invention. Here the adjustable post member 8 has numerous receptor holes 22 where multiple detachable massage device posts 12 may be attached (see FIG. 6 where multiple posts 12 are attached through receptor holes 22).

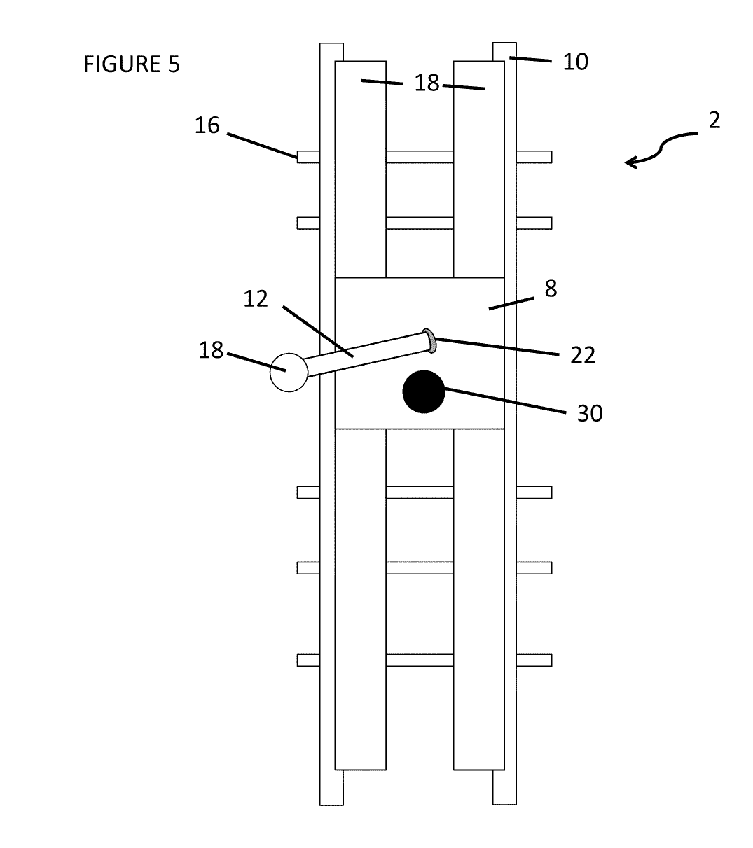

FIG. 5 illustrates a front perspective view of another embodiment of the current invention. Here, the device 2 may have a pair of elongated substantially parallel base members 10. The elongated base members are attached to a support structure like a wall by elongated substantially parallel attachment struts 16. Along the base members 10 may be an elongated track 18 where the adjustable post member 8 may be slideably attached to the elongated track. The post member 8 may be adjusted upwardly or downwardly depending on the user's desired height with an adjustment fixture 30. A detachable massage device post 12 would be inserted in the receptor hole 22 within the adjustable post member 8.

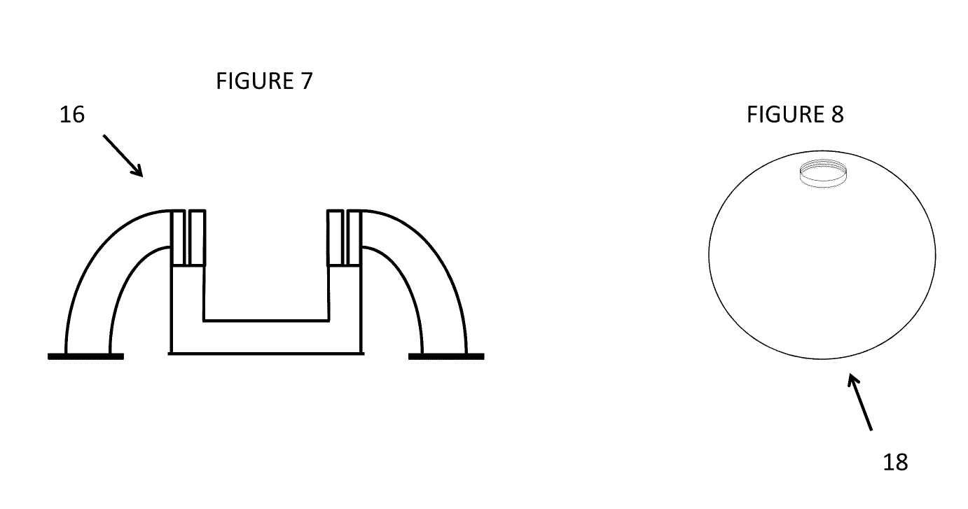

FIG. 7 is a front perspective view of the attachment struts 16 used to connect the therapeutic compression apparatus to a supporting structure like a wall.

In one embodiment, there exists a portable system comprising a similar base-and-post to the industrial/home version. The contact devices would be the same and interchangeable with those used with the industrial/home version.

In several embodiments, the device could be fastened to a supporting structure such as a wall, frame, or column. The system may be mounted via numerous embodiments, which may include screws, bolts, removable clamps and other such affixing mechanisms known in the art. Apertures may be set through the base of the device base in order to receive the fasteners.

The receiving holes to fit the massage device post are deep enough to provide a secure fit, resist compression as well as horizontal and vertical forces from the user.

The massage device post is strong and durable to resist similar forces from a user without breaking, shearing, or stripping.

The base may have a silicon/rubber gasket with a lever mechanism to adjust suction attachment to a wall or door at the desired height for use. The device would be easily assembled/disassembled for easy travel.

In several embodiments, the apparatus may access the posterior anatomy of the human body including the neck, back, hips, shoulders, arms, thighs, and calves. The apparatus may be adjusted to provide adequate force and pressure when applied to the target area in need. The pressure remains variable and adjustable to the user's preference and need.

Furthermore, the apparatus allows for adequate access to a user's target area from multiple angles: on a horizontal plane, 0-270 degrees of rotation around the target area; vertical access to the target area from above and below.

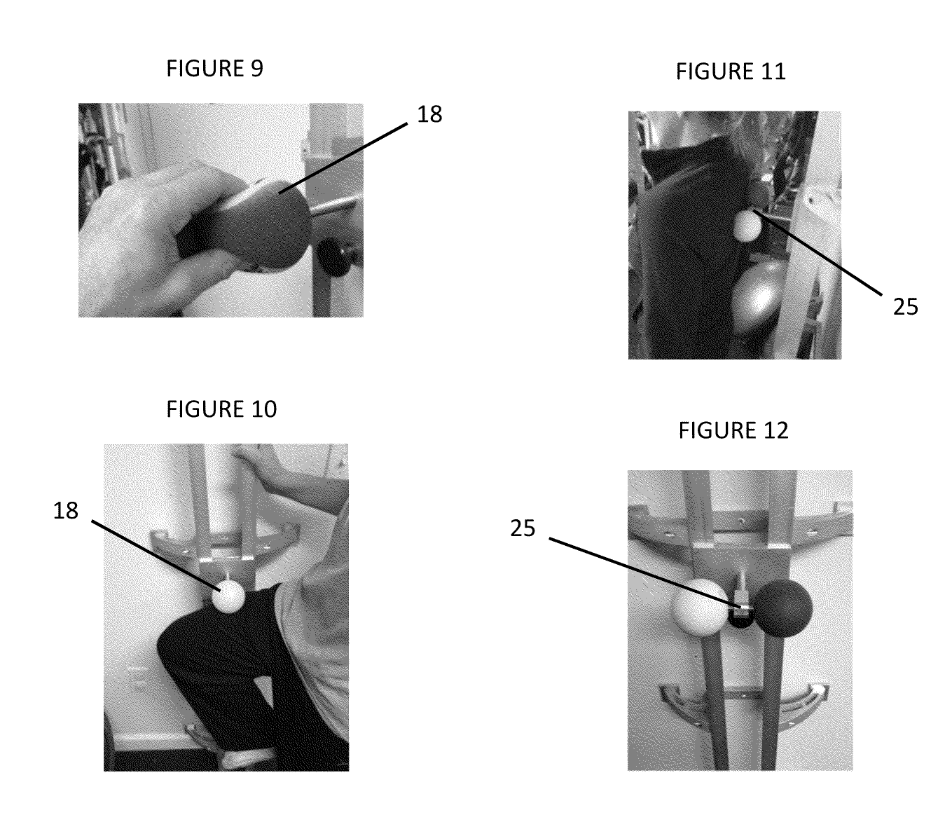

As illustrated in FIGS. 9-12, in summation, the instant system comprises numerous highly unique advantages as the point of contact with the user can be easily adjusted in numerous ways as discussed below.

The overall diameter of the contact surface can be adjusted to the needs of the user and the contact surface can be narrow or broad as shown.

The overall density of the contact point can also be adjusted to the needs of the user, as illustrated in FIG. 9 and the contact point can be soft and pliable; alternatively the contact point can be more firm, but ‘stickier’ or very slick such as in Teflon® and resin balls and thus these different contact points may be utilized for different parts of the body, as illustrated in FIG. 10.

The images show spheres of varying diameters as the points of contact; the spheres can be interchanged with other shapes (ex: cylinder with a longer broad point of contact; a cone with a narrow point of contact) depending upon the needs of the user.

As previously discussed, the user can easily adjust the ‘pressure’ of his/her tissue upon the point of contact by simply adjusting the degree of lean up against the device. Thus the user has multiple ways to adjust accordingly to the different areas of the body that requires the treatment.

As further illustrated in FIGS. 11 and 12, a dual spherical device 25 can be added that can be used to massage the paraspinal muscles while avoiding contact on the posterior spinal processes when doing so by creating an adequate ‘gap’ in the points of contact and avoiding painful contact on the spine bones themselves—something that is common with a solid cylindrical contact point such as a foam roller, commonly known in the art.

Additionally, the contact point is easily exchanged by unscrewing the unit from the post that attaches to the track, shown by the center image above. Moreover, a unique aspect of the design is the post mechanism which allows the point of contact to rest a significant distance from the wall—something essentially impossible with floor units. Simply employing a sphere or object such as a sphere above placed against the wall and leaning on it is incredibly inefficient and does not allow the user to maximize the use of the sphere against the ‘hot spot’ because the user is limited by the diameter of the sphere itself. The post allows the sphere—or other contact point—to be placed approximately 8-10 inches from the wall as shown in the upper left and right images above. This allows the user to 270 degrees of horizontal freedom around the contact point which is impossible to achieve from a floor or stand-alone sphere device up against a wall; and,

Therefore, the device can be adjusted to the desired vertical height to meet the needs of the user and treat the specific area. Both the posterior as well as the anterior tissues can be treated with the device. The degree of pressure on the particular area being treated can easily be adjusted by the degree of lean, upward, or downward pressure applied onto the contact point by the user. The surface point of the contact can also be adjusted by interchanging the contact device. Finally the user can also rotate horizontally around the contact point because of the distance of the contact point from the wall. This allows a far more effective and deep tissue treatment.

In several embodiments, the apparatus may utilize detachable massage device posts that vary in size and surface area. The differing sizes and surface areas allows for adequate contact to the tissues and allows for the user to apply effective therapeutic compression therapy to the desired target area. Detachable massage device posts may be small enough to fir between spinous processes, between muscle bellies and tendons. The detachable massage device may be large enough to apply adequate application to entire muscle groups.

The detachable massage device posts have differing head shapes including spheres, pegs, dual spheres, and cylinders. These heads may vary in size depending on the size of the target area. Further, the heads may vary in density depending if a user needs soft, compressible material, while others may need/want hard/slick material.

Other embodiments will occur to those skilled in the art and are within the following claims:

What is claimed is:

1. A therapeutic compression apparatus, comprising:
a pair of elongated substantially parallel structural base members, further comprising:
a plurality of substantially parallel attachment struts positioned between the pair of elongated substantially parallel structural base members;
an elongated track attached to the elongated substantially parallel structural base members;
at least one adjustable post member slideably attached to the elongated track; and,
at least one detachable massage device post.

2. The therapeutic compression apparatus of claim 1, wherein the pair of elongated substantially parallel structural base members may be attached to a support structure by the plurality of substantially parallel attachment struts.

3. The therapeutic compression apparatus of claim 1, where the pair of elongated substantially parallel structural base members are vertically positioned against the support structure.

4. The therapeutic compression apparatus of claim 1, where the at least one adjustable post member is vertically adjusted along the elongated track.

5. The therapeutic compression apparatus of claim 1, wherein the at least one adjustable post member is vertically adjusted the length of the pair of elongated substantially parallel structural base members.

6. The therapeutic compression apparatus of claim 1, wherein the at least one adjustable post member has at least one receptor hole for accepting the at least one detachable massage device post.

7. The therapeutic compression apparatus of claim 1, wherein the at least one detachable massage device post is attached to the at least one adjustable post member through the receptor hole on the post member.

8. The therapeutic compression apparatus of claim 1, wherein, the at least one detachable massage device post has a distance long enough to reach a user's desired contact point.

9. The therapeutic compression apparatus of claim 1, wherein the at least one detachable massage device post rotates up to 270 degrees around an axis of the user's desired contact point.

10. The therapeutic compression apparatus of claim 1, wherein the therapeutic compression apparatus has a 360 degrees vertical orientation.

11. The therapeutic compression apparatus of claim 1, wherein the at least one massage device post is selected from a group of differing massage heads consisting of spheres, pegs, dual spheres, cylinders, and differing compressible material.

12. The therapeutic compression apparatus of claim 11, wherein the group of differing massage heads comprises at least two message heads.

13. The therapeutic compression apparatus of claim 1, wherein the substantially parallel attachment further comprises a vibration device.

14. A method of utilizing a therapeutic compression apparatus comprising the steps of:
attaching the pair of structural base members to a stable surface;
attaching at least one vertically disposed elongated track system to the base system;
attaching at least one adjustable post retaining member;
attaching at least one post member to the adjustable post retaining member;
attaching at least one treatment member comprising a point of contact; and,
positioning the at least one treatment member to a portion of a body requiring treatment.

15. A method of treating muscles using a therapeutic compression apparatus comprising the steps of:
choosing a user's desired detachable massage device post;
attaching the detachable massage device post to an adjustable post member wherein, the detachable massage device post extends away from a support structure and the distance from the support structure allows the user to rotate the contact point up to 270 degrees around the axis of a contact point;
positioning the adjustable post member slideably to the user's desired contact point; and,
treating the user's desired contact point wherein, the user treats the contact point in a 360 degree vertical orientation.
